(19) United States
(12) Patent Application Publication
(10) Pub. No.: US 2026/0117830 A1
(43) Pub. Date: Apr. 30, 2026

(54) Belted Disc

(71) Applicants: Spencer Edwin Daw, Agoura Hills, CA (US); Molly Sharon Daw, Agoura Hills, CA (US); Duncan Howard Daw, Agoura Hills, CA (US); Dylan Mitchell Daw, Agoura Hills, CA (US)

(72) Inventors: Spencer Edwin Daw, Agoura Hills, CA (US); Molly Sharon Daw, Agoura Hills, CA (US); Duncan Howard Daw, Agoura Hills, CA (US); Dylan Mitchell Daw, Agoura Hills, CA (US)

(21) Appl. No.: 18/932,618

(22) Filed: Oct. 31, 2024

(51) Int. Cl. F16D 65/12

(52) U.S. Cl. CPC F16D 65/127

(57) ABSTRACT

A disc for a disc-brake as used in a vehicle. The disc includes an elevated metallic rim or belt completely encircling the said disc's perimeter edge on either or both sides with the said belted area protruding perpendicularly for about one or two inches from and relative to the flat side(s) of the disc and with the said belt further comprising an edge or thickness of approximately one-half inch.

### BACKGROUND OF THE INVENTION

This invention relates to a disc in a vehicle disc-brake system and more particularly to the problem of needing a greater friction torsional or torque mechanical advantage on a friction contact surface area of a disc that is otherwise constrained by diameter limitations.

The disc of a conventional disc-brake system is generally a flat circular metallic plate that is connected at its centerpoint to a road wheel at its centerpoint such that they are both attached to a common axle or axis around which they jointly and synchronously spin. When the road wheel turns, the attached disc must also turn and if the said disc is caused to slow or stop the connected road wheel must synchronously slow or stop. The manual forced slowing or stopping of the said disc is the braking effect.

The manual forced slowing of the disc is accomplished through the use of brake pads (friction agents) using a clamping motion to simultaneously apply equal and opposing forced sliding friction pressure onto the flat sides of the spinning disc. This clamping motion requires two separate pad contact areas and two separate pads, that is, one pad contact area and one pad for each side of the clamped disc. The mechanism that holds and deploys the said clamping pistons and pads is referred to as a brake caliper and there is usually one brake caliper per disc.

The pad contact areas of a traditional disc begin at the perimeter of the flat sides of the disc and then extend inward and toward the disc's centerpoint thereby defining about a 2 or 3 inch wide annular area around the outermost 2 or 3 inches on each side of the disc. These pad contact areas are smooth, flat, surfaces where the complementary and equally smooth, flat, and approximately 2 or 3 inch high and 3 or 4 inch wide (long) brake pads make a pressurized clamping sliding friction contact with the spinning disc in the said annular pad contact area to accomplish the said braking effect.

A larger diameter disc will provide a greater mechanical advantage in the frictional slowing or stopping of a disc, versus a smaller diameter disc, by providing a longer lever, that is, the distance from the fulcrum, in this case the axle or centerpoint of the disc, to the end of the lever, that is, the friction area toward the perimeter of the disc. Brake disc diameters are generally limited by a vehicles tire or rim size. Larger diameter brake discs are generally more efficient and preferred for this mechanical advantage.

The Belted Disc moves the location of the conventional disc's brake pad contact area(s) from its conventional flat vertical side(s) to the inner and outer side surfaces of an integral belt that is part of the disc itself; this belt being an area elevated and protruding perpendicularly from the said disc's side in an arcing manner completely surrounding the said disc's side perimeter. Said integral perpendicular elevated area, or belt itself, will be raised about one or two inches from the disc's side and have a thickness of, or an edge depth of, about ½ inch. The belted area is the Belted Disc's pad contact area and must be of a thickness to be suitable to to be clamped by two opposing pressurized brake pads, one pad on its inner surface and another on its outer surface, to accomplish the said braking effect.

For clarity and consistency the herein descriptions of the said Belted Disc, including the Drawings, will be utilizing a vehicle disc as installed meaning with its sides vertical to the ground, like a tire, and having an outboard and an inboard side unless specifically noted otherwise. The said installed fixed caliper and its pads and their interaction with the disc will be considered from the perspective of the said pads being at a 12 o'clock position on the disc, that is, directly vertical and above the centerpoint of the said disc. Vehicle calipers can be, and are, installed at positions other than 12 o'clock and using that position in the description is not suggesting a required or even preferred location but strictly for clarity and consistency in illustrating a concept.

A defining characteristic of a Belted Disc is that the perpendicular clamped surfaces on the said belt concentrate greater friction potential and mechanical advantage to a disc without the necessity of increasing the disc's diameter. The said belt is clamped from an essentially horizontal perspective (up/down) when the pads are at a fixed 12:00 o'clock position and from an essentially vertical perspective (left/right) if the pads are installed at a 3:00 o'clock position but at either or any position the clamped surfaces will always be perpendicular to their base, that is, to the flat sides of the disc.

Vehicle disc-brake systems are a mature technology with a rich history of research and development which has been done; and continues to provide optimum performance for both the pad and the disc including configurations, force pressures, sizes, and compositions of components, for efficiency, usability, and durability. Regarding the brake disc itself there have been refinements and advances to improve disc cooling and to clear pad residue via holes or slots in the disc itself and roughing or scoring of the disc's pad contact area to stabilize the brake pad and thereby quell or minimize pad squeal, judder and knocking and to generally improve brake feel.

The specific measurements used herein are not meant as required or even suggested regarding sizes but as an aid to communicating a concept. This invention is not pertaining to manufacturing processes, the operation of disc brakes in general or to specific materials; but, is limited to the relocating of the pad contact area(s) of the brake disc itself. The disc-brake system can be dual piston, floating single piston, or other and can include split disc, solid disc or other configurations.

### SUMMARY OF THE INVENTION

A primary objective of this invention is to provide a disc for a disc-braking system that increases that systems efficiency and efficacy in engaging, maintaining and sustaining braking by altering and relocating the disc's pad contact area(s) to the said disc's extreme outer perimeter thereby maximizing the available mechanical advantage at the disc's pad contact surface area(s).

The increasing of the disc braking system's mechanical advantage is accomplished by relocating the disc's pad contact surface area(s) to the extreme outer ½ inch of its perimeter. This optimized relocation is accomplished through the use of a belted disc braking system. A belted disc provides, at or near and surrounding its perimeter, on either or both sides, a belt, band or rim that perpendicularly protrudes about an inch or two from the flat side(s) of the said disc with the said belt having a thickness of approximately ½ inch. The said described belt's inner and outer surfaces are the belted disc's pad contact areas.

Having the said ½ inch thick belt protruding 1 inch (for example) on the outboard side of the disc being engaged by the clamping motion of two brake discs, that is, one applied onto its inner and another onto its (the belts) outer surface by, for example, opposing 1 inch wide x 3 inch long brake pads would result in having a disc friction contact of 6 square inches on the said disc's outboard side. Each belt of the Belted Disc requires two opposing brake pads for a total of four brake pads when each side of the disc has a belt. Assuming the same configuration on the said disc's inboard side there would be a total of 12 square inches of surface friction contact, from a total of four brake pads, all applied onto the outermost ½ inch of the disc, that is, the same ½ inch comprising the thickness of the belt(s) from their location at the outermost area of the said disc's side perimeter.

Comparatively, a traditional disc/pad system would require two 2 inch wide x 3 inch long pads, that is one pad per side, to equal the 12 square inches of friction surface contact as the above described double belted system; but, the friction force from the conventional system would be spread as far as 2 inches from the more efficient outer perimeter of the disc versus the Belted Disc's more efficient ½ inch.

When viewed from a disc's cutaway edge view perspective the top half of a belted disc with belted protrusions on both sides, as in the above example, will present in the likeness of a capital ‘T’ with the disc contact areas being the upper and lower surfaces of the top crossing bar of the exposed ‘T’ as will be more fully explained in the later drawings and descriptions.

Another characteristic of a Belted Disc is that the disc, but not including the disc belt itself, does not need to be fit for interacting with a brake pad because the disc's side(s) are no longer the pad contact area(s). Accordingly, the structural support for the described pad contact area belt(s) may not need to be metal and may even be spoked or otherwise.

A Belted Disc will employ similar concepts and materials but with reconfigured hardware as is used in a traditional disc-braking system while placing the pad contact area into a much more efficient location resulting in a more efficient and effective braking system.

Another benefit of a belted disc is being able to employ the belt on just one side of the disc. This one sided belt configuration could be helpful when certain side clearances are required or preferred.

Other advantages and constructions of this invention will become apparent from the following detailed descriptions of some preferred embodiments when considered with the accompanying drawings.

### BRIEF DESCRIPTION OF THE DRAWINGS

FIG. 1 is a diagrammatic frontal view of a generic conventional automotive disc-braking system including the orientation and inclusion of an edge view perspective of its disc.

FIG. 2 is a diagrammatic half section cutaway and partially revolved perspective showing the outboard side of a double belted brake disc with its upper right quadrant removed thereby simultaneously showing both its outboard side and an exposed cut half section view of its edge and belts.

FIG. 3 is a magnified diagrammatic view of the top half of FIG. 1 but now including the as modified disc from FIG. 2 as the disc being shown from the same edge view perspective as the disc in FIG. 1. Removing the disc's upper right quadrant allows viewing the disc's belted features from an edge view perspective which said shaped features would otherwise be hidden or obscured by the belt's arced nature and its width. The relationship of the disc with its brake pads is also shown.

### DETAILED DESCRIPTION OF A FEW PREFERRED EMBODIMENTS

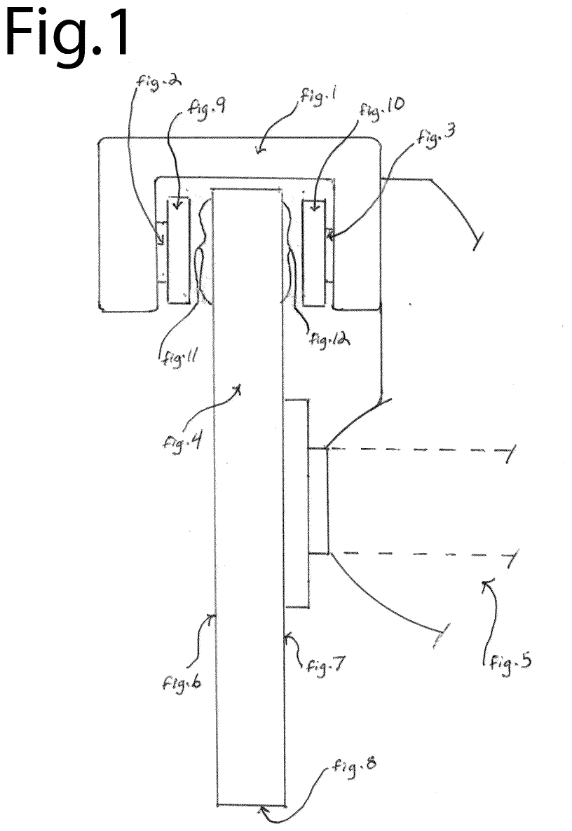

FIG. 1 depicts a generic automotive disc-braking system and is included for background, perspective and to illustrate the general operation of a conventional disc-brake system including a caliper 1, being the mechanism which houses and deploys two separate and opposing sliding pistons, 2 and 3, which simultaneously and forcefully extend when braking thereby applying a clamping effect against the disc, 4, via the friction agents (brake pads) 9 and 10, attached to the tips of the said pistons, causing the slowing or stopping the disc's spinning. It includes showing the non-rotational fixed nature of the caliper, and therefore the brake pads, onto the hub/axle housing of the vehicle as FIG. 5. The disc is further described as having an outboard side 6 and an inboard side 7 and also an edge 8.

The disc (4) is further defined as having pad contact areas that are the specific areas of the disc that are or may be contacted by the pads during braking and are denominated as 11 (on outboard side 6) and 12 (on inboard side 7). FIG. 1 shows the rotor and brake pads in a non-pressurized/non-friction state and therefore a non-braking state.

The shown FIG. 1 is a dual piston caliper and one-piece disc but this invention pertains to any disc/piston configuration including floating one-piston calipers and/or split discs.

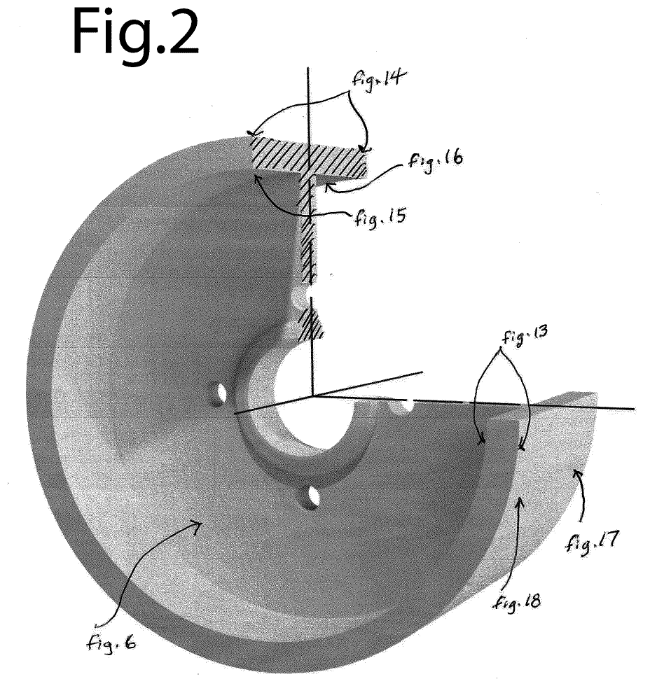

FIG. 2 shows a half section cut and partially revolved perspective of a belted disc with belted configurations on both the outboard side and the inboard side. The disc has been revolved about 25 degrees so that the outboard side 6 and the edge of the rotor 8 are concurrently visible. A “pie slice” segment comprising the disc's upper right quadrant has been removed as indicated by the cut line P, thereby exposing the disc's inner surface 19 (identified via section lines) showing the vertical stem of the disc with the horizontal (as shown) perpendicular raised (relative to the flat support stem/aka disc sides) belted nature of the disc that is hidden by the width (from an edge view) of the double belted disc and also due to the arcing nature of the hidden features. The belt features are further identified as having an edge 13 thickness of approximately ½ inch. The totality of the span of the double belt including the stem 19 is identified as 27. The outer pad contact surface of the outboard side belt is identified as 18 and the said belt's inner pad contact surface as 15. The outer pad contact surface of the inboard side belt is 17 with its inner pad contact surface as 16.

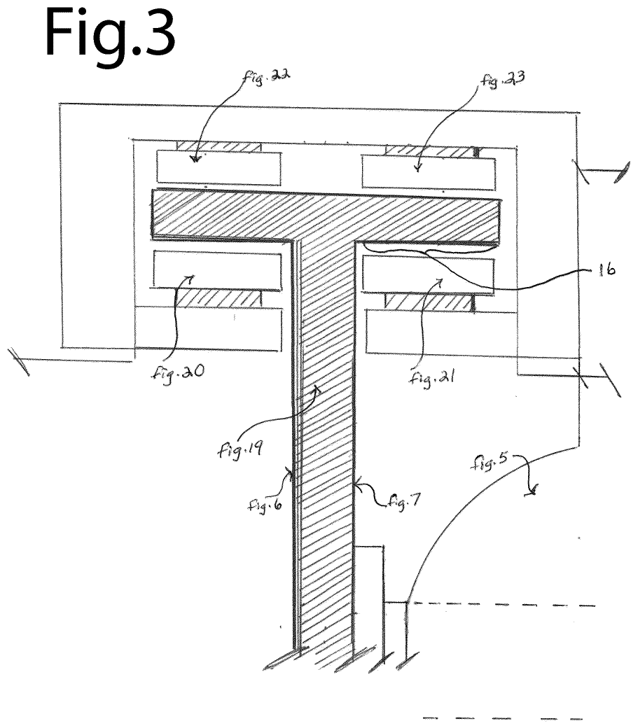

FIG. 3 is generally a view of a portion of the upper half of the braking system FIG. 1 but in this depiction the original generic disc 4 has been replaced by the modified disc as described in FIG. 2 such that the visible portion of the disc is a half section cut view of the exposed inner vertical Y axis surface 19 as identified by section lines, remaining after the removal of the disc's upper right quadrant. This edge view is a 90 degree revolved view relative to a flat side view.

The former flat pad contact areas 11 and 12 of the disc 4 in the traditional generic disc braking system FIG. 1 have been replaced on the disc's outboard side 6 by a belted, as defined, perpendicular pad contact area with said belt's outer (upper) pad contact area as 18 and its inner (lower) pad contact area as 15. The disc's outboard side shows its belt positioned to be clamped between its contact surface 18 by the complementary brake pad 22 and by pad 20 on pad surface 15. The inboard pad contact area 12 has also been replaced by a belted configuration with said belt having an outer (upper) pad contact area 17 and a lower (inner) pad contact area 16 positioned to be clamped by pad 23 (onto 17) and pad 21 onto 16.

Complementary brake pads are referenced and shown from a cutaway perspective to help illustrate a concept. Complementary brake pads will, of necessity, be arced and of an appropriate material and configuration.

As presented, the drawing shows the nature of the disc's double belted features as being in the configuration of a capital ‘T’ with its pad contact area(s) being the upper and under sides of the capital T's top crossing bar. It is anticipated that this double-belted, ‘T’ sort of configuration will be the generally preferred embodiment but any configuration of a belted, perpendicular pad contact area could be used, for example, split belts (similar to a split disc) or having one big brake pad cover the outer contact surface over the entirety of the top of a crossing ‘T’ feature.

The above illustrations and commentary are presented as some examples of preferred embodiments that exemplify the crux and spirit of the invention but they are not exclusive and those skilled in the art may present further variations and modifications so long as they don't deviate from the spirit or scope of the invention.

What is claimed is:

1. A disc for a vehicle disc-brake system, said disc comprising, on one or both sides and at or near the disc's perimeter:
an elevated annular belt or ridge protruding perpendicularly for one to three inches from the disc's flat side for the purpose of providing a pad contact area to be engaged by brake pads; and
encircling the entirety of the disc; and
having an edge thickness of about one-half inch or as required for proper clamping pressurized sliding friction from a brake pad; and
being integral to or firmly attached to the said disc; and
of a metal or material suitable for brake force sliding friction pressure by a brake pad; and
with said disc being comprised as above by virtue of original construction, modification or otherwise, by cast, forge or other manufacturing or production processes, and being inclusive of any and all construction methods, modifications, and/or materials.
